(19) United States
(12) Patent Application Publication
(10) Pub. No.: US 2007/0090097 A1
(43) Pub. Date: Apr. 26, 2007

(54) Laser welding system for welding workpiece

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry Co., LTD., Tu-Cheng City (TW)

(21) Appl. No.: 11/473,965

(22) Filed: Jun. 23, 2006

(30) Foreign Application Priority Data
Oct. 26, 2005 (CN) 200510100781.2

(51) Int. Cl. B23K 26/26

(52) U.S. Cl. 219/121.63; 219/121.82

(57) ABSTRACT

An exemplary laser welding system for welding workpiece includes a laser generating system, a supporting system, and a control system. The laser generating system is configured for applying laser beams to the workpiece. The supporting system is configured for supporting the workpiece thereon. The supporting system includes a holder and a cooler disposed on the holder. The holder is configured for supporting the workpiece thereon and the cooler is configured for absorbing heat generated due to welding of the workpiece. The control system is configured for detecting a welding surface of the workpiece on the holder of the supporting system thereby obtaining a feedback signal associated therewith and correspondingly controlling the laser generating system to apply the laser beam to the workpiece so as to weld the workpiece according to the feedback signal. The workpiece can achieve a smooth welding surface.

### TECHNICAL FIELD

The present invention relates to welding systems, and more particularly to a laser welding system for welding workpiece that can achieve smooth welding surfaces.

### BACKGROUND

Welding generally is to unite metal parts by applying heat, sometimes with pressure and sometimes with an intermediate or filler metal having a low melting point. Typical welding processes include electric welding, seamless welding, or carbon dioxide shielded arc welding.

The electric welding process generally utilizes electricity across the gap from the tip of the welding electrode to the base metal to create the heat needed for melting and joining the metal parts. The seamless welding process is an adaptation of electric welding and involves making a series of overlapping spot welds by means of rotating copper alloy wheel electrodes to form a continuous leak tight joint. Carbon dioxide shielded arc welding is where two items are joined by heating using the carbon dioxide gas as protection gas.

The laser welding processes are different to the above-mentioned processes in that they use laser beams to generate the needed heat in order to properly weld two metal parts together. The laser welding process gives many advantages over typical welding processes including flexibility, versatility, cost-effectiveness, and precision control.

However, in the fields of electronics and communications, products not only require high precision, but also an ergonomic outline. Speed of typical laser welding process is fast, however some heat around the welding surface of a workpiece is not dissipated quickly and cools unevenly as a result the surface formed is also uneven and the workpiece has non-ergonomic outline.

What is needed, therefore, is a laser welding system for welding workpiece that can achieve smooth welding surfaces.

### SUMMARY

In a preferred embodiment, a laser welding system for welding workpiece includes a laser generating system, a supporting system, and a control system. The laser generating system is configured for applying laser beams to the workpiece. The supporting system is configured for supporting the workpiece thereon. The supporting system includes a holder and a cooler disposed on the holder. The holder is configured for supporting the workpiece thereon and the cooler is configured for absorbing heat generated due to welding of the workpiece. The control system is configured for detecting a welding surface of the workpiece on the holder of the supporting system thereby obtaining a feedback signal associated therewith and correspondingly controlling the laser generating system to apply the laser beam to the workpiece so as to weld the workpiece according to the feedback signal

Other advantages and novel features will become more apparent from the following detailed description of the present laser welding system for welding workpiece when taken in conjunction with the accompanying drawings.

### BRIEF DESCRIPTION OF THE DRAWINGS

Many aspects of the laser welding system for welding workpiece can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a schematic view of a laser welding system for welding workpiece, in accordance with a preferred embodiment; and

FIG. 2 is a schematic, enlarged view showing a welding surface roughness of the workpiece.

### DETAILED DESCRIPTION OF PREFERRED EMBODIMENT

Reference will now be made to the drawing figures to describe the preferred embodiment of the present laser welding system for welding workpiece in detail.

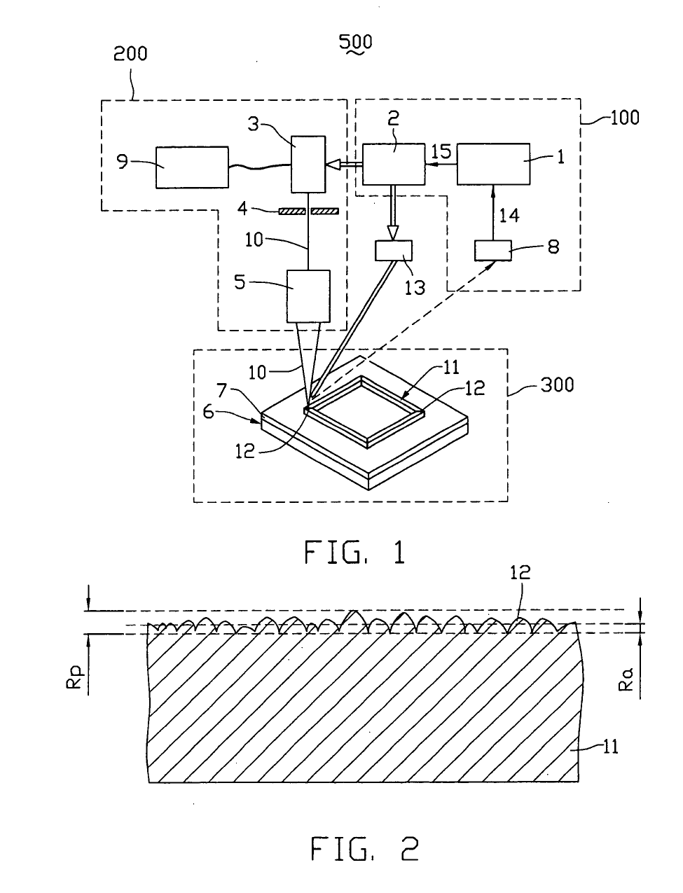

Referring to FIG. 1, a laser welding system 500 for welding workpiece in accordance with a preferred embodiment is shown. The welding system 500 includes a control system 100, a laser generating system 200, and a supporting system 300.

The control system 100 is connected electronically with the laser generating system 200. The laser generating system 200 emits laser beams 10 and the laser beams 10 impinge on a workpiece 11 held by the supporting system 300. The control system 100 detects a welding surface 12 of the workpiece 11 and generates a feedback signal 14 and further controls the laser generating system 200 based on the feedback signal 14. Thereby the control system 100, the laser generating system 200, and the supporting system 300 cooperatively form a feedback loop.

The control system 100 includes a signal processing unit 1, a controller 2, and a detector 8 connected in series.

The detector 8 can be an optical detector for detecting intensity of the laser beams 10 on the welding surface 12 and then generating and transmitting the feedback signal 14 to the signal processing unit 1. As more laser beams 10 impinge on the welding surface 12, the intensity of the laser beams 10 becomes greater and the temperature of the welding surface 12 becomes higher. If fewer laser beams 10 impinge on the welding surface 12, the intensity becomes less and the temperature becomes lower. The detector 8 can be a temperature detector for detecting the temperature of the welding surface 12. The feedback signal 14 can represent the intensity or temperature of the welding surface 12.

The signal processing unit 1 processes the feedback signal 14 and thereby generates a control signal 15. The controller 2 receives the control signal 15 and controls the laser generating system 200 to emit the laser beams 10. If the intensity of the laser beams 10 on the welding surface 12 is greater, the controller 2 controls the laser generating system 100 to emit fewer laser beams 10, if the intensity of the laser beams 10 is lower, the laser generating system 100 will emit more laser beams 10. The control signal 15 is selected from the group consisting of laser pulse, pulse duration, and pulse repetition rate according to the processing unit 1.

The laser generating system 200 includes a laser 3, a shutter 4, a lens module 5, and a cooling module 9.

The laser 3 is connected to the controller 2 and emits the laser beams 10 based on the control signal 15 transmitted from the controller 2.

The laser 3 is one of a solid-state laser, a crystal laser, and a glass laser according to the material of the workpiece 11. The laser 3 is selected from the group consisting of an Nd (neodymium)-YAG (yttrium aluminium garnet) laser with a wavelength of 1064 nanometers, an Yb (ytterbium)-YAG laser with a wavelength of 940 nanometers, and an Nd-Vanadate laser with a wavelength of from 1047 nanometers to 1064 nanometers.

The shutter 4 is configured to allow the laser beams 10 to pass through or be blocked. The laser beams 10 passing through the shutter 4 can impinge on the lens module 5.

The lens module 5 is configured for focusing the laser beams 10. The lens module 5 includes a number of lenses and can achieve a tight focus. After the laser beams 10 pass through the lens module 5 and are focused on the workpiece 11 in a small light spot. The light spot has a size in the range from about 1 micron to 1000 microns, and preferably in the range from 1 micron to 100 microns.

The cooling module 9 is connected to the laser 3 for cooling the laser 3, thus keeping the laser 3 within normal working conditions.

The supporting system 300 includes a holder 6 and at least one cooler 7 disposed on the holder 6. The holder 6 is used to support the workpiece 11. The holder 6 can rotate in any direction.

The cooler 7 can be a thermal electric cooler. The cooler 7 can be disposed on any surfaces of the holder 6 according to requirement. The cooler 7 can dissipate the heat generate by the laser beams 10 on the welding surface 12 of the workpiece 11 in a timely fashion. Therefore, temperature of welding surface 12 cools uniformly and the welding surface 12 is smooth.

The laser welding system 500 further includes a protection gas system 13 for blowing protection gas onto the welding surface 12 of the workpiece 11. The protection gas system 13 is connected to the controller 2 and is controlled by the controller 2.

Operation of the laser welding system 500 is described in detail below.

The laser welding system 500 is turned on. The signal processing unit 1 is setup with a parameter, such as the control signal 15, and transmits the control signal 15 to the controller 2. The controller 2 controls the laser 3 to emit the laser beams 10 based on the control signal 15. The workpiece 11 is settled on the holder 6. The shutter 4 is opened and allows the laser beams 10 pass through the lens module 5 and the laser beams 10 impinge onto the welding surface 12 of the workpiece 11. During the process, the cooler 7 dissipates the heat generated by the laser beams 10 in a timely fashion. The detector 8 detects the intensity information of the welding surface 12 and transforms the information into the feedback signal 14. The signal processing unit 1 processes the feedback signal 14 and outputs the control signal 15 to the controller 2. The controller 2 controls the laser 3 to emit the laser beams 10. Repeat this process until the workpiece 11 is finished.

Referring to FIG. 2, average deviation of surface roughness for the workpiece 11 is labeled with a character Ra and maximum peak value of surface roughness is labeled with a character Rp. Ra of the workpiece 11 by the laser welding system 500 is in the range from about 0.5 nanometers to 2 nanometers and Rp is in the range from about 1.5 nanometers to 6 nanometers. Therefore, the welding surface 12 of the workpiece 11 can be considered to have a smooth surface.

Although the present invention has been described with reference to specific embodiments, it should be noted that the described embodiments are not necessarily exclusive, and that various changes and modifications may be made to the described embodiments without departing from the scope of the invention as defined by the appended claims.

What is claimed is:

1. A laser welding system for welding workpiece, comprising:
a laser generating system configured for applying a laser beam to the workpiece;
a supporting system configured for supporting the workpiece thereon, the supporting system including a holder and a cooler disposed on the holder, the holder being configured for supporting the workpiece thereon and the cooler being configured for absorbing heat generated due to welding of the workpiece; and
a control system configured for detecting a welding surface of the workpiece on the holder of the supporting system thereby obtaining a feedback signal associated therewith and correspondingly controlling the laser generating system to apply the laser beam to the workpiece so as to weld the workpiece according to the feedback signal.

2. The laser welding system as claimed in claim 1, wherein the cooler is a thermo electric cooler.

3. The laser welding system as claimed in claim 1, wherein the laser generating system comprises a laser for emitting the laser beams, a shutter for controlling exposure of the workpiece to the laser beams, and a lens module configured for focusing the laser beams.

4. The laser welding system as claimed in claim 3, wherein the laser is selected from the group consisting of a Nd-YAG laser with a wavelength of 1064 nanometers, a Yb-YAG laser with a wavelength of 940 nanometers, and a Nd-Vanadate laser with a wavelength of from 1047 nanometers to 1064 nanometers.

5. The laser welding system as claimed in claim 3, wherein the lens module comprise a plurality of lenses.

6. The laser welding system as claimed in claim 3, wherein the laser beams applied on the workpiece appears to be a light spot with a spot having a size in the range from about 1 micron to about 1000 microns.

7. The laser welding system as claimed in claim 3, wherein the laser generating system further comprises a cooling module configured for cooling the laser.

8. The laser welding system as claimed in claim 1, wherein the control system comprises a detector, a signal processing unit, and a controller connected in series.

9. The laser welding system as claimed in claim 8, wherein the detector is an optical detector for detecting intensity of the laser beams on the welding surface of the workpiece.

10. The laser welding system as claimed in claim 8, wherein the detector is a temperature detector for detecting temperature of the welding surface.

11. The laser welding system as claimed in claim 1, further comprising a protection gas system for blowing a protection gas onto the welding surface of the workpiece, the protection gas system connected with the control system.
